(19) United States
(12) Patent Application Publication
(10) Pub. No.: US 2017/0025759 A1
(43) Pub. Date: Jan. 26, 2017

(54) MOBILE DEVICE

(71) Applicant: Quanta Computer Inc., Taoyuan City (TW)

(72) Inventors: Chi-Hsuan LEE, Taoyuan City (TW); Chung-Ting HUNG, Taoyuan City (TW); Tsung-Ying HSIEH, Taoyuan City (TW)

(21) Appl. No.: 14/880,479

(22) Filed: Oct. 12, 2015

(30) Foreign Application Priority Data
Jul. 20, 2015 (TW) 104123370

(51) Int. Cl. H01Q 9/04; H01Q 1/38

(52) U.S. Cl. CPC H01Q 9/04; H01Q 1/38

(57) ABSTRACT

A mobile device includes a ground plane, an antenna element, and at least one extension element. The ground plane has a first region and a second region. The antenna element is disposed on the first region. The extension element has an open end and a connection end. The connection end of the extension element is coupled to a side of the second region. The extension element is configured to enhance the radiation gain of the antenna element in a zenith direction.

### CROSS REFERENCE TO RELATED APPLICATIONS

This Application claims priority of Taiwan Patent Application No. 104123370 filed on Jul. 20, 2015, the entirety of which is incorporated by reference herein.

### BACKGROUND OF THE INVENTION

Field of the Invention

The disclosure generally relates to a mobile device, and more specifically, to a mobile device with an antenna element.

Description of the Related Art

With the progress of mobile communication technology, mobile devices, for example, portable computers, mobile phones, tablet computers, multimedia players, and other hybrid functional portable electronic devices, have become more common. To satisfy the demand of users, mobile devices usually can perform wireless communication functions. Some functions cover a large wireless communication area; for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area; for example, mobile phones using Wi-Fi and Bluetooth systems and using frequency bands of 2.4 GHz, 5.2 GHz, and 5.8 GHz.

GPS (Global Positioning System) is an important technology for positioning in wireless communication systems nowadays, and it is almost a standard element for every mobile device. However, a GPS antenna usually cannot align its maximum gain direction with the zenith direction because there is limited space in the mobile device, resulting in the problem of an imprecise position process.

### BRIEF SUMMARY OF THE INVENTION

In a preferred embodiment, the invention is directed to a mobile device including a ground plane, an antenna element, and a first extension element. The ground plane has a first region and a second region. The antenna element is disposed on the first region. The first extension element has an open end and a connection end. The connection end of the first extension element is coupled to a first side of the second region.

In some embodiments, the mobile device also includes a second extension element. The second extension element has an open end and a connection end. The connection end of the second extension element is coupled to a second side of the second region.

In some embodiments, a length of each of the first extension element and the second extension element is equal to 0.25 wavelength of a central operation frequency of the antenna element.

In some embodiments, the antenna element is a GPS (Global Positioning System) antenna disposed toward a zenith direction.

In some embodiments, the first extension element and the second extension element are configured to enhance radiation gain of the antenna element in the zenith direction.

In a preferred embodiment, the invention is directed to a mobile device including a ground plane and an antenna element. The ground plane has a first region and a second region. The antenna element is disposed on the first region. A first slot is formed on the second region of the ground plane. The first slot has an open end and a closed end. The open end of the first slot is positioned at a first side of the second region.

In some embodiments, a second slot is formed on the second region of the ground plane, the second slot has an open end and a closed end, and the open end of the second slot is positioned at a second side of the second region.

In some embodiments, a length of each of the first slot and the second slot is equal to 0.25 wavelength of a central operation frequency of the antenna element.

In some embodiments, the antenna element is a GPS (Global Positioning System) antenna disposed toward a zenith direction.

In some embodiments, the first slot and the second slot are configured to enhance radiation gain of the antenna element in the zenith direction.

### BRIEF DESCRIPTION OF DRAWINGS

The invention can be more fully understood by reading the subsequent detailed description and examples with references made to the accompanying drawings, wherein:

FIG. 1A is a top view of a mobile device according to an embodiment of the invention;

FIG. 1B is a side view of a mobile device according to an embodiment of the invention;

FIG. 2 is a diagram of return loss of an antenna element of a mobile device according to an embodiment of the invention;

FIG. 3 is a 3D (Three-dimensional) diagram of gain of an antenna element when a mobile device includes no extension element;

FIG. 4 is a 3D diagram of gain of an antenna element when a mobile device includes a first extension element and a second extension element, according to an embodiment of the invention;

FIG. 5A is a top view of a mobile device according to an embodiment of the invention;

FIG. 5B is a side view of a mobile device according to an embodiment of the invention;

FIG. 6 is a diagram of return loss of an antenna element of a mobile device according to an embodiment of the invention; and

FIG. 7 is a 3D diagram of gain of an antenna element when a mobile device has a first slot and a second slot, according to an embodiment of the invention.

### DETAILED DESCRIPTION OF THE INVENTION

In order to illustrate the purposes, features and advantages of the invention, the embodiments and figures of the invention are shown in detail as follows.

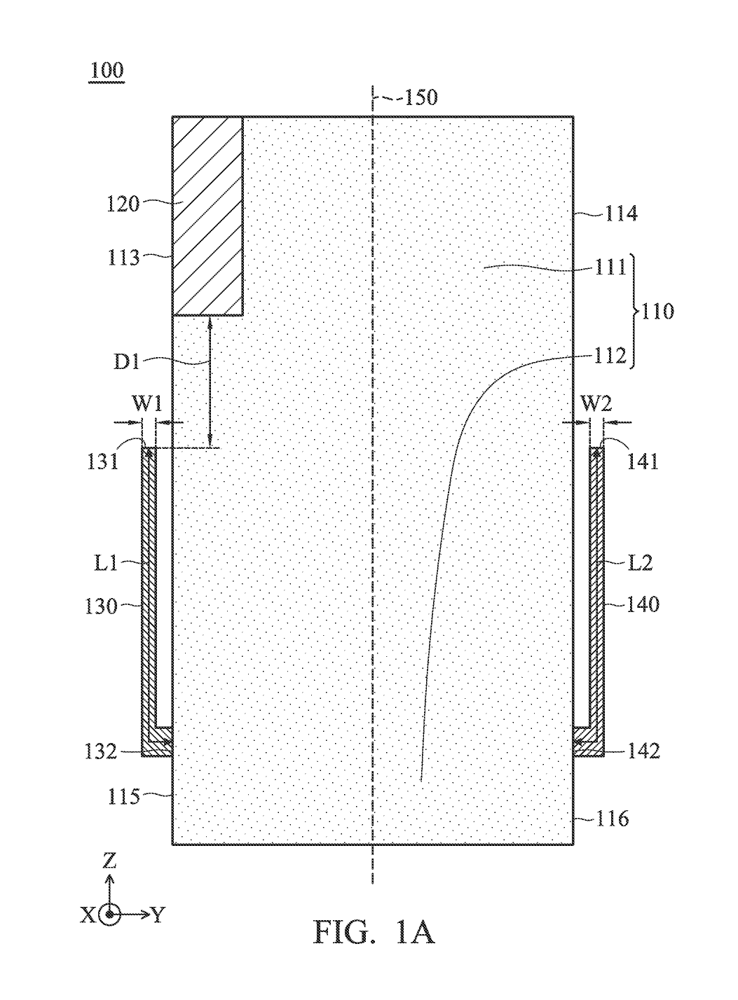

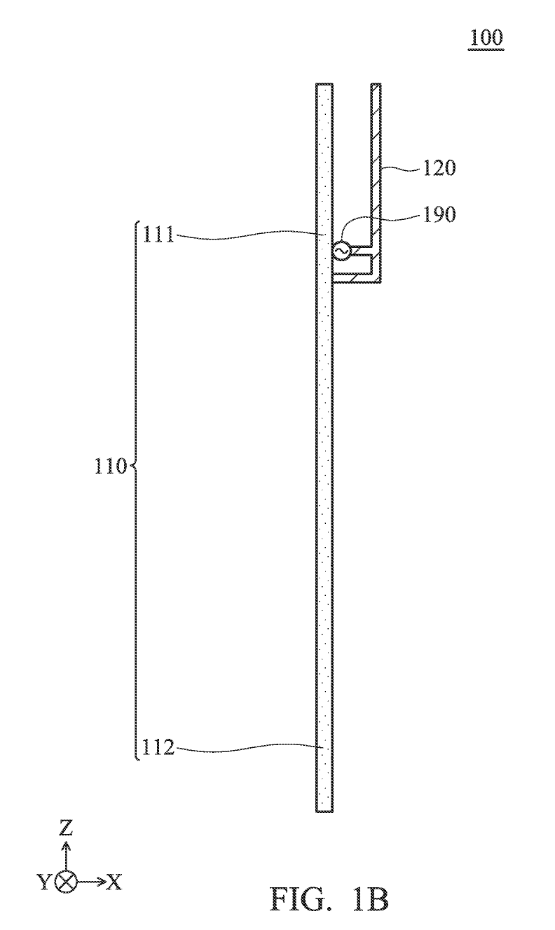

FIG. 1A is a top view of a mobile device 100 according to an embodiment of the invention. FIG. 1B is a side view of the mobile device 100 according to an embodiment of the invention. Please refer to FIG. 1A and FIG. 1B together. The mobile device 100 may be a smartphone, a tablet computer, or a notebook computer. As shown in FIG. 1A and FIG. 1B, the mobile device 100 includes a ground plane 110, an antenna element 120, a first extension element 130, and a second extension element 140. The ground plane 110, the antenna element 120, the first extension element 130, and the second extension element 140 are made of conductive materials, such as copper, silver, aluminum, iron, or their alloys. It should be understood that the mobile device 100 can further include other components, such as a processor, a display device, a touch control module, a battery, and a housing (not shown).

The ground plane 110 substantially has a rectangular shape, and it has a first region 111 and a second region 112. The first region 111 is positioned at an upper portion of the ground plane 110 and toward a zenith direction (e.g., the +Z axis direction in figures). The second region 112 is positioned at a lower portion of the ground plane 110 and toward a ground direction (e.g., the −Z axis direction in figures). The antenna element 120 is disposed on the first region 111 of the ground plane 110. The shape and type of the antenna element 120 are not limited in the invention. For example, the antenna element 120 may be a monopole antenna, a dipole antenna, a loop antenna, a helical antenna, a PIFA (Planar Inverted F Antenna), or a chip antenna. The first extension element 130 and the second extension element 140 are disposed adjacent to the second region 112 of the ground plane 110. In alternative embodiments, the mobile device 110 includes either the first extension element 130 or the second extension element 140. The first extension element 130 and the second extension element 140 may be integrated with the ground plane 110, and they may be printed on a plane of the same dielectric substrate.

In the embodiment of FIG. 1A and FIG. 1B, the inner components of the mobile device 100 are arranged as follows. It should be understood that these contents are just exemplary for readers to understand the invention easily, but they are not limitations of the scope of claims of the present application.

The antenna element 120 is a GPS (Global Positioning System) antenna. For example, the antenna element 120 may be a PIFA (Planar Inverted F Antenna) excited by a signal source 190. The antenna element 120 is positioned at a first side 113 of the first region 111 so as to form an asymmetrical arrangement, and it is disposed toward the zenith direction (e.g., the +Z axis direction in figures). In alternative embodiments, the antenna element 120 is positioned at a second side 114 of the first region 111.

The first extension element 130 substantially has an L-shape. The first extension element 130 has an open end 131 and a connection end 132. The connection end 132 of the first extension element 130 is coupled to a first side 115 of the second region 112. The open end 131 of the first extension element 130 extends toward the antenna element 120. The second extension element 140 substantially has an L-shape. The second extension element 140 has an open end 141 and a connection end 142. The connection end 142 of the second extension element 140 is coupled to a second side 116 of the second region 112. The open end 141 of the second extension element 140 extends toward the antenna element 120. The second side 116 of the second region 112 is opposite to the first side 115 of the second region 112. More specifically, the length L1 of the first extension element 130 is equal to 0.25 wavelength (λ/4) of a central operation frequency of the antenna element 120, and the length L2 of the second extension element 140 is also equal to 0.25 wavelength of the central operation frequency of the antenna element 120. The width W1 of the first extension element 130 is equal to the width W2 of the second extension element 140. In other words, the first extension element 130 and the second extension element 140 are symmetrical with respect to a central line 150 of the second region 112. With such a design, the antenna element 120, the first extension element 130, and the second extension element 140 all resonate in a GPS frequency band. The first extension element 130 and the second extension element 140 are configured to enhance the radiation gain of the antenna element 120 in the zenith direction.

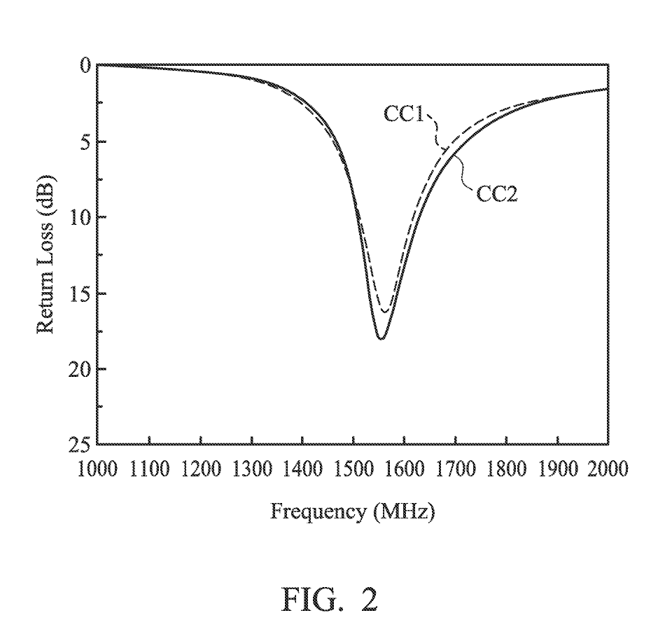

FIG. 2 is a diagram of return loss of the antenna element 120 of the mobile device 100 according to an embodiment of the invention. The horizontal axis represents the operation frequency (MHz), and the vertical axis represents the return loss (dB). A first curve CC1 represents the operation characteristics of the antenna element 120 when the mobile device 100 includes no extension element, and its resonant frequency is from about 1520 MHz to about 1610 MHz. A second curve CC2 represents the operation characteristics of the antenna element 120 when the mobile device 100 includes the first extension element 130 and the second extension element 140, and its resonant frequency is from about 1510 MHz to about 1630 MHz. According to the measurement of FIG. 2, after the first extension element 130 and the second extension element 140 are added, the bandwidth of the antenna element 120 increases by about 2.1% in comparison to that of the original arrangement. Therefore, the first extension element 130 and the second extension element 140 can help to improve the impedance matching of the antenna element 120.

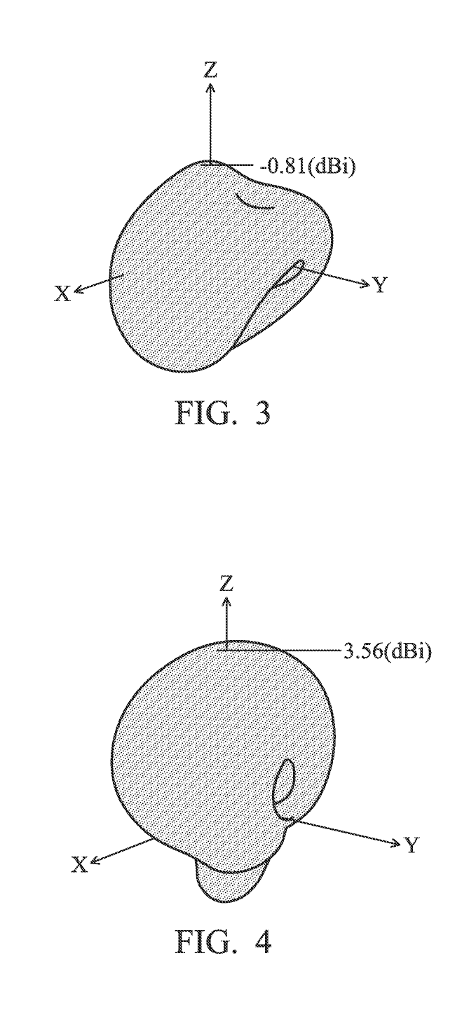

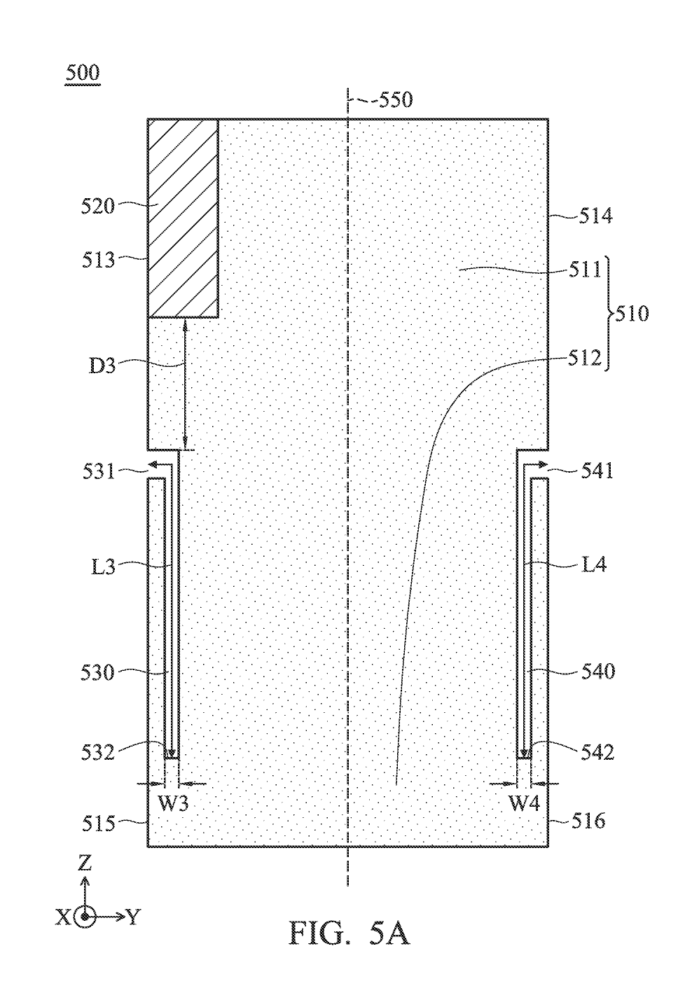

FIG. 3 is a 3D (Three-dimensional) diagram of gain of the antenna element 120 when the mobile device 100 includes no extension element, and the antenna element 120 has antenna gain of about −0.81 dBi in the zenith direction (e.g., the +Z axis direction in figures). FIG. 4 is a 3D diagram of gain of the antenna element 120 when the mobile device 100 includes the first extension element 130 and the second extension element 140, according to an embodiment of the invention, and the antenna element 120 has antenna gain of about 3.56 dBi in the zenith direction (e.g., the +Z axis direction in figures). According to the measurement of FIG. 3 and FIG. 4, after the first extension element 130 and the second extension element 140 are added into the mobile device 100, the radiation gain of the antenna element 120 is improved by 4.37 dBi in the zenith direction, and therefore the first extension element 130 and the second extension element 140 can help to improve the performance of the corresponding GPS.

In some embodiments, the element sizes of the mobile device 100 are as follows. Please refer to FIG. 1A and FIG. 1B again. The length L1 of the first extension element 130 is from about 40 mm to about 44 mm, and is preferably 42 mm. The width W1 of the first extension element 130 is from about 1 mm to about 3 mm, and is preferably 2 mm. The length L2 of the second extension element 140 is from about 40 mm to about 44 mm, and is preferably 42 mm. The width W2 of the second extension element 140 is from about 1 mm to about 3 mm, and is preferably 2 mm. The spacing D1 between the open end 131 of the first extension element 130 (or the open end 141 of the second extension element 140) and the antenna element 120 is from about 8 mm to about 12 mm, and is preferably 10 mm.

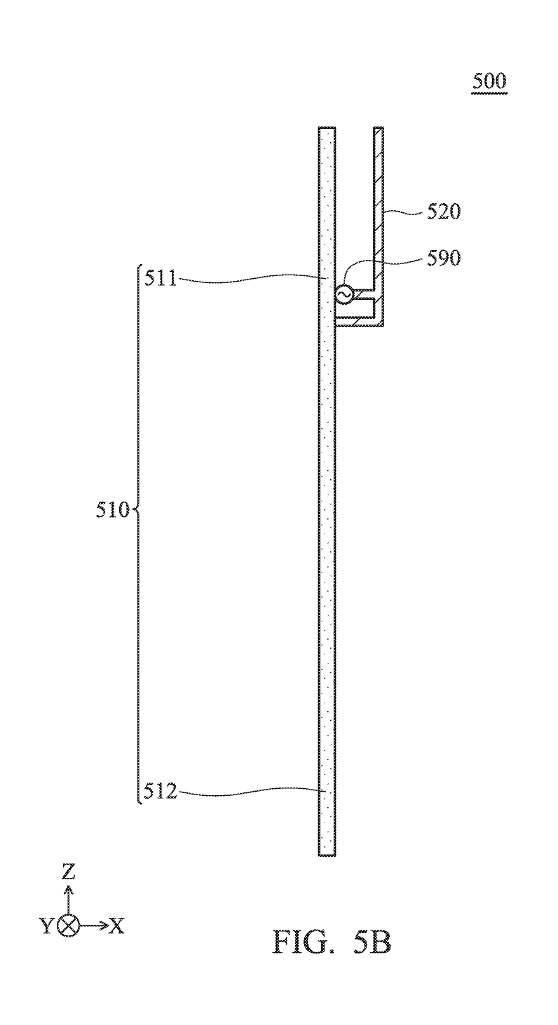

FIG. 5A is a top view of a mobile device 500 according to an embodiment of the invention. FIG. 5B is a side view of the mobile device 500 according to an embodiment of the invention. Please refer to FIG. 5A and FIG. 5B together. The mobile device 500 may be a smartphone, a tablet computer, or a notebook computer. As shown in FIG. 5A and FIG. 5B, the mobile device 500 includes a ground plane 510 and an antenna element 520. The ground plane 510 and the antenna element 520 are made of conductive materials, such as copper, silver, aluminum, iron, or their alloys. It should be understood that the mobile device 500 can further include other components, such as a processor, a display device, a touch control module, a battery, and a housing (not shown).

The ground plane 510 substantially has a rectangular shape, and it has a first region 511 and a second region 512. The first region 511 is positioned at an upper portion of the ground plane 510 and toward a zenith direction (e.g., the +Z axis direction in figures). The second region 512 is positioned at a lower portion of the ground plane 510 and toward a ground direction (e.g., the −Z axis direction in figures). The antenna element 520 is disposed on the first region 511 of the ground plane 510. The shape and type of the antenna element 520 are not limited in the invention. For example, the antenna element 520 may be a monopole antenna, a dipole antenna, a loop antenna, a helical antenna, a PIFA (Planar Inverted F Antenna), or a chip antenna. A first slot 530 and a second slot 540 are formed on the second region 512 of the ground plane 510. In alternative embodiments, the second region 512 of the ground plane 510 has either the first slot 530 or the second slot 540. The first slot 530 and the second slot 540 may be integrated with the ground plane 510, and they may be printed on a plane of the same dielectric substrate.

In the embodiment of FIG. 5A and FIG. 5B, the inner components of the mobile device 500 are arranged as follows. It should be understood that these contents are just exemplary for readers to understand the invention easily, but they are not limitations of the scope of claims of the present application.

The antenna element 520 is a GPS (Global Positioning System) antenna. For example, the antenna element 520 may be a PIFA (Planar Inverted F Antenna) excited by a signal source 590. The antenna element 520 is positioned at a first side 513 of the first region 511 so as to form an asymmetrical arrangement, and it is disposed toward the zenith direction (e.g., the +Z axis direction in figures). In alternative embodiments, the antenna element 520 is positioned at a second side 514 of the first region 511.

The first slot 530 substantially has an L-shape. The first slot 530 has an open end 531 and a closed end 532. The open end 531 of the first slot 530 is positioned at a first side 515 of the second region 512. The closed end 532 of the first slot 530 extends away from the antenna element 520. The second slot 540 substantially has an L-shape. The second slot 540 has an open end 541 and a closed end 542. The open end 541 of the second slot 540 is positioned at a second side 516 of the second region 512. The closed end 542 of the second slot 540 extends away from the antenna element 520. The second side 516 of the second region 512 is opposite to the first side 515 of the second region 512. More specifically, the length L3 of the first slot 530 is equal to 0.25 wavelength (λ/4) of a central operation frequency of the antenna element 520, and the length L4 of the second slot 540 is also equal to 0.25 wavelength of the central operation frequency of the antenna element 520. The width W3 of the first slot 530 is equal to the width W4 of the second slot 540. In other words, the first slot 530 and the second slot 540 are symmetrical with respect to a central line 550 of the second region 512. With such a design, the antenna element 120, the first slot 530, and the second slot 540 all resonate in a GPS frequency band. The first slot 530 and the second slot 540 are configured to enhance the radiation gain of the antenna element 520 in the zenith direction.

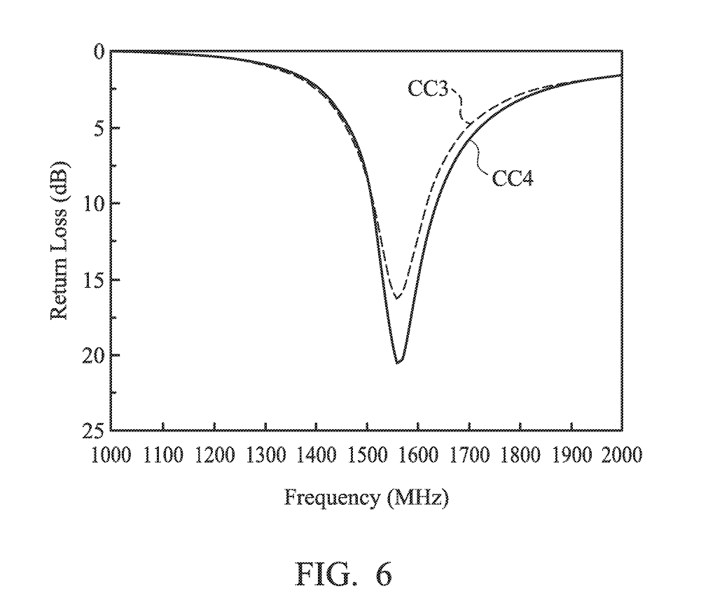

FIG. 6 is a diagram of return loss of the antenna element 520 of the mobile device 500 according to an embodiment of the invention. The horizontal axis represents the operation frequency (MHz), and the vertical axis represents the return loss (dB). A third curve CC3 represents the operation characteristics of the antenna element 520 when the mobile device 500 has no slot, and its resonant frequency is from about 1520 MHz to about 1610 MHz. A fourth curve CC4 represents the operation characteristics of the antenna element 520 when the mobile device 500 has the first slot 530 and the second slot 540, and its resonant frequency is from about 1510 MHz to about 1630 MHz. According to the measurement of FIG. 6, after the first slot 530 and the second slot 540 are added, the bandwidth of the antenna element 520 increases by about 2.1% in comparison to that of the original arrangement. Therefore, the first slot 530 and the second slot 540 can help to improve the impedance matching of the antenna element 520.

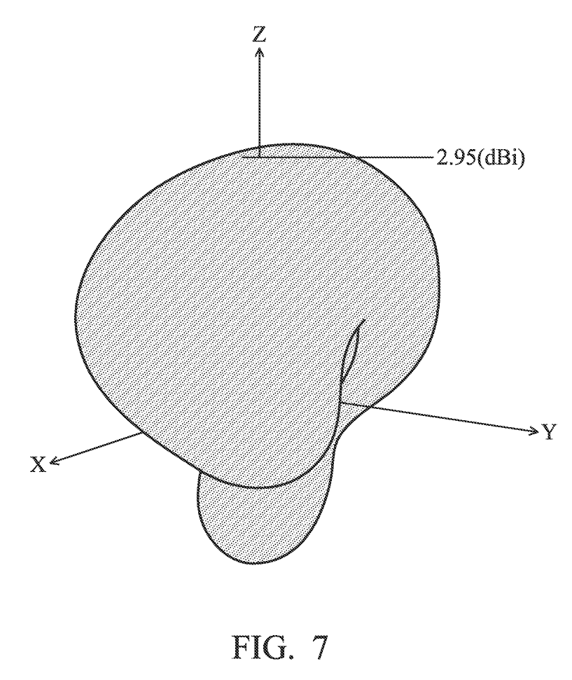

FIG. 7 is a 3D diagram of gain of the antenna element 520 when the mobile device 500 has the first slot 530 and the second slot 540, according to an embodiment of the invention, and the antenna element 520 has antenna gain of about 2.95 dBi in the zenith direction (e.g., the +Z axis direction in figures). According to the measurement of FIG. 3 and FIG. 7, after the first slot 530 and the second slot 540 are added into the mobile device 500, the radiation gain of the antenna element 520 is improved by 3.76 dBi in the zenith direction, and therefore the first slot 530 and the second slot 540 can help to improve the performance of the corresponding GPS.

In some embodiments, the element sizes of the mobile device 500 are as follows. Please refer to FIG. 5A and FIG. 5B again. The length L3 of the first slot 530 is from about 40 mm to about 44 mm, and is preferably 42 mm. The width W3 of the first slot 530 is from about 1 mm to about 3 mm, and is preferably 2 mm. The length L4 of the second slot 540 is from about 40 mm to about 44 mm, and is preferably 42 mm. The width W4 of the second slot 540 is from about 1 mm to about 3 mm, and is preferably 2 mm. The spacing D3 between the open end 531 of the first slot 530 (or the open end 541 of the second slot 540) and the antenna element 520 is from about 8 mm to about 12 mm, and is preferably 10 mm.

The invention proposes a mobile device combining an antenna element with an extension element or a slot of a ground plane. The extension element or the slot of the ground plane can resonate with the antenna element at the same frequency. With such a design, the extension element or the slot is configured to change the surface current distribution on the ground plane. The extension element or the slot can modify the radiation pattern of the antenna element so that the maximum gain direction of the antenna element is consistent with the zenith direction. According to the practical measurements of the above embodiments, the extension element and the slot have similar impact on the antenna element. In comparison to conventional designs, the invention at least has the advantages of enhancing the antenna gain in the zenith direction, improving the GPS performance, reducing the manufacturing cost, and simplifying the antenna structure, and it is suitable for application in a variety of small-size mobile communication devices.

Note that the above element sizes, element shapes, and frequency ranges are not limitations of the invention. An antenna engineer can adjust these settings or values according to different requirements. It should be understood that the mobile device of the invention is not limited to the configurations of FIGS. 1-7. The invention may merely include any one or more features of any one or more embodiments of FIGS. 1-7. In other words, not all of the features shown in the figures should be implemented in the mobile device of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A mobile device, comprising:
a ground plane, having a first region and a second region;
an antenna element, disposed on the first region; and
a first extension element, having an open end and a connection end, wherein the connection end of the first extension element is coupled to a first side of the second region.

2. The mobile device as claimed in claim 1, further comprising:
a second extension element, having an open end and a connection end, wherein the connection end of the second extension element is coupled to a second side of the second region.

3. The mobile device as claimed in claim 2, wherein a length of each of the first extension element and the second extension element is equal to 0.25 wavelength of a central operation frequency of the antenna element.

4. The mobile device as claimed in claim 2, wherein the antenna element is a GPS (Global Positioning System) antenna disposed toward a zenith direction.

5. The mobile device as claimed in claim 4, wherein the first extension element and the second extension element are configured to enhance radiation gain of the antenna element in the zenith direction.

6. A mobile device, comprising:
a ground plane, having a first region and a second region; and
an antenna element, disposed on the first region;
wherein a first slot is formed on the second region of the ground plane, the first slot has an open end and a closed end, and the open end of the first slot is positioned at a first side of the second region.

7. The mobile device as claimed in claim 6, wherein a second slot is further formed on the second region of the ground plane, the second slot has an open end and a closed end, and the open end of the second slot is positioned at a second side of the second region.

8. The mobile device as claimed in claim 7, wherein a length of each of the first slot and the second slot is equal to 0.25 wavelength of a central operation frequency of the antenna element.

9. The mobile device as claimed in claim 7, wherein the antenna element is a GPS (Global Positioning System) antenna disposed toward a zenith direction.

10. The mobile device as claimed in claim 9, wherein the first slot and the second slot are configured to enhance radiation gain of the antenna element in the zenith direction.
